(19) United States
(12) Patent Application Publication
(10) Pub. No.: US 2012/0177345 A1
(43) Pub. Date: Jul. 12, 2012

(54) Automated Video Creation Techniques

(76) Inventors: Matthew Joe Trainer, San Diego, CA (US); Troy Michael George Gardner, West Hollywood, CA (US)

(21) Appl. No.: 13/346,618

(22) Filed: Jan. 9, 2012

Related U.S. Application Data
(60) Provisional application No. 61/431,038, filed on Jan. 9, 2011.

(51) Int. Cl. H04N 5/93; G10L 13/08

(52) U.S. Cl. 386/285; 704/260; 704/E13.001; 386/E05.003

(57) ABSTRACT

Various technologies and techniques are disclosed for automatically creating videos from text. A video creation system automatically creates videos from text. The text to be converted is received. Images are located that corresponds to the subject matter in the text. Music for the video is selected. A spoken version of the text is created using text-to-speech conversion, or through an uploaded recording. A video is created using the images, music, and voice. The video is made available for playback, downloading, and/or submission to other systems. A blog/web site plug-in is disclosed that automatically creates a video from an article on the site. An automated video creation system is disclosed that includes a video creation module that receives text, images, music, video, and/or narration from a user. The video creation module creates the video from the user input along with programmatically selected inputs that include text, images, music, video, and/or narration.

### CROSS-REFERENCE TO RELATED APPLICATIONS

This application claims the benefit of U.S. Provisional Application No. 61/431,038, filed Jan. 9, 2011, the entire disclosure of which is hereby incorporated by reference for all purposes as if fully set forth herein.

### BACKGROUND

In today's world of technology, everyone can be a publisher of information. More and more people are producing their own videos, articles, and/or audio files and are distributing those files all over the Internet. For example, with popular blogging tools such as Word Press and Blogger, it is easy to create your own blog in a few minutes, and then publish your articles on that blog as desired.

There are also several video tools that allow users to create high quality videos. With these video creation tools, users can upload their own photos if desired, choose background music, upload video footage, and/or capture screen recordings to show a demonstration. The user can then add transitions, overlays, animations, and other features to the video to give the video a more professional look and feel. Once the user is satisfied with the video, he/she can have the video created from all the inputs.

While there are numerous tools that exist for video creation and editing, they tend to either require a significant amount of human editing in order to produce high quality videos, or they tend to produce low quality videos. There exists a need for improved ways to create videos.

### SUMMARY

Various technologies and techniques are disclosed for automatically creating videos from text. In one implementation, a video creation system automatically creates videos from text. The text to be converted into a video is received. The subject matter(s) in the text are identified. One or more images are located that correspond to the subject matter(s) contained in the text. Music to be used in the video is selected. A spoken version (audio narration) of the text is generated using text-to-speech conversion, or through an uploaded recording. A video is created using the selected images, music (when selected), text, and/or audio narration. The video is made available for playback, downloading, and/or submission to other systems.

In another implementation, techniques for server management and auto scaling are disclosed for automatically scaling the servers being used in the creation of videos.

In yet another implementation, a blog/web site plug-in is disclosed that automatically creates a video from an article on the site. In one implementation, the video is automatically created whenever a new article is posted onto a particular page on the web site. In another implementation, the video is created upon user request after a new article has been posted to a particular page on the web site.

An automated video creation system is disclosed that includes a video creation module that receives text, images, music, video, and/or narration from a user. The video creation module then creates the video using the input from the user along with programmatically selected inputs that include text, images, music, video, and/or narration. The programmatically selected inputs are selected at least in part based upon the at least one input from the user. This allows the user to supply as much or as little inputs as desired, while the system can then programmatically select other inputs for the user, and then use the various inputs to create the video.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a video creation system of one implementation.

FIG. 2 is a process flow diagram for one implementation illustrating the stages involved in automatically creating a video from text that has been supplied.

FIGS. 3A-3B are a process flow diagram illustrating the more detailed stages involved in creating a video from text in another implementation.

FIG. 4 is a simulated screen for one implementation that illustrates a plug-in for a blog or web site that facilitates automated video creation.

FIG. 5 is a simulated screen for one implementation that illustrates a settings page for configuring an automated video creation plug-in for a blog or web site.

FIG. 6 is a simulated screen for one implementation that illustrates a user interface that allows a user to input text and other settings that are used to automatically create a video.

FIG. 7 is a diagrammatic view of a video creation system of another implementation.

FIGS. 8A-8B are a simulated screen for another implementation that illustrates a plug-in for a web site that facilitates automated video creation.

FIGS. 9-10 are simulated screens for another implementation that illustrate selecting images to include in the video.

FIG. 11 is a diagrammatic view of a computer system of one implementation.

### DETAILED DESCRIPTION

The technologies and techniques herein may be described in the general context as an application that automates the creation of videos, but the technologies and techniques also serve other purposes in addition to these. In one implementation, one or more of the techniques described herein can be implemented as features within a web site builder, a blogging tool, a video creation tool, or from any other type of program or service that creates, displays, and/or uses videos.

In one implementation, a video creation system is described that automatically creates videos from text. The video creation system can be used as a plug-in in conjunction with a blog or other web site, such as to automatically create a video that corresponds to the subject matter discussed in a particular article or post. Alternatively or additionally, the video creation system can be used as a standalone video creation tool that automates the creation of a video from text that is provided to the video creation system.

In another implementation, a video creation system is described that allows a user to specify one or more inputs, including text, images, music, video, and/or narration. The user basically supplies as much or as little inputs as desired, while the system then programmatically selects other inputs for the user, and then uses the various inputs (both user selected and programmatically selected) to create the video.

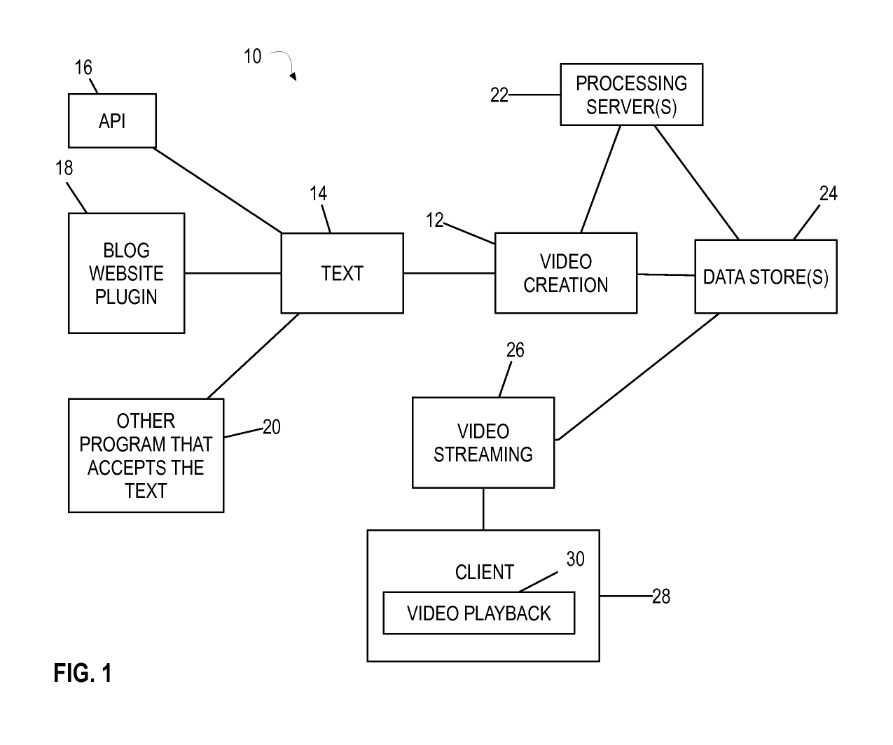

FIG. 1 is a diagrammatic view of a video creation system 10 of one implementation. Video creation system 10 has a video creation module 12 that receives text 14 from one or more sources. For example, text 14 can include text that will be converted into a video using video creation system 10, such as the text of an article or blog post. Text 14 can be received from another program through an API 16, through a plug-in 18 on a blog or other web site, and/or through another program 20 that accepts the text as input. Alternatively or additionally, API 16 can allow for the text of articles or blog posts to be remotely retrieved and used with video creation system 10. Various techniques can be used to obtain text 14 for use with video creation module 12, as would occur to someone of reasonable skill in the field of computer science.

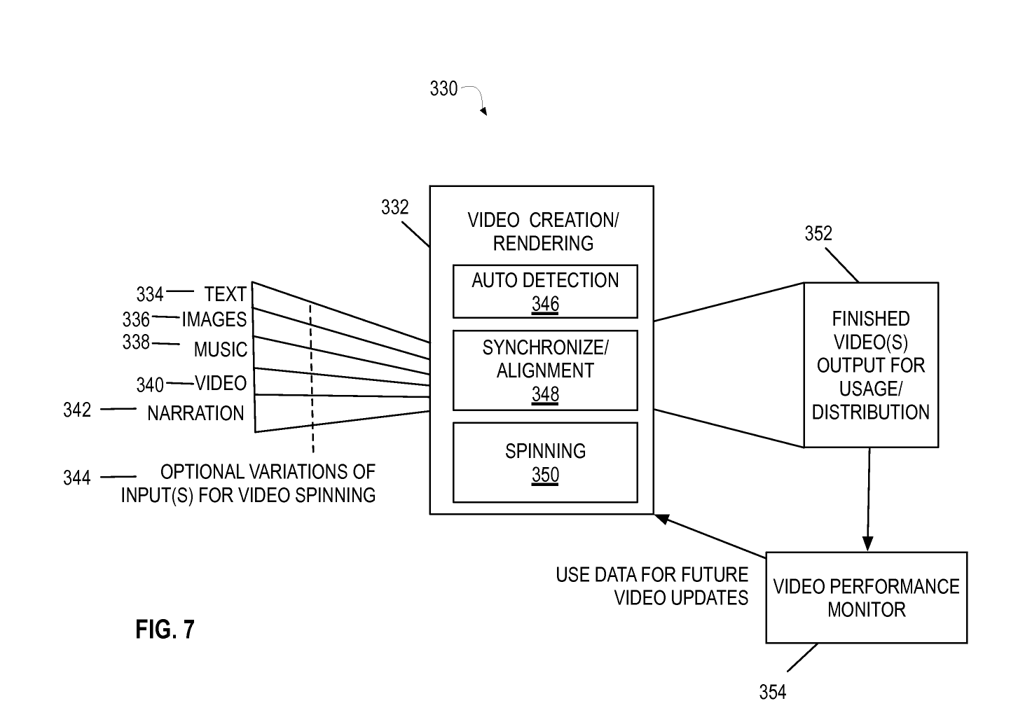

Once text 14 (or one/more of various inputs [such as text, images, music, video, and/or narration] as described in FIG. 7) is/are received by the video creation module 12, one or more processing server(s) 22 are used to create the video. In one implementation, processing server(s) 22 are different servers than the server that is running the video creation module 12. In another implementation, processing server(s) 22 are the same server that is running the video creation module 12. Numerous combinations of one or more servers could be used for creating the videos, and this configuration is just shown for illustration purposes.

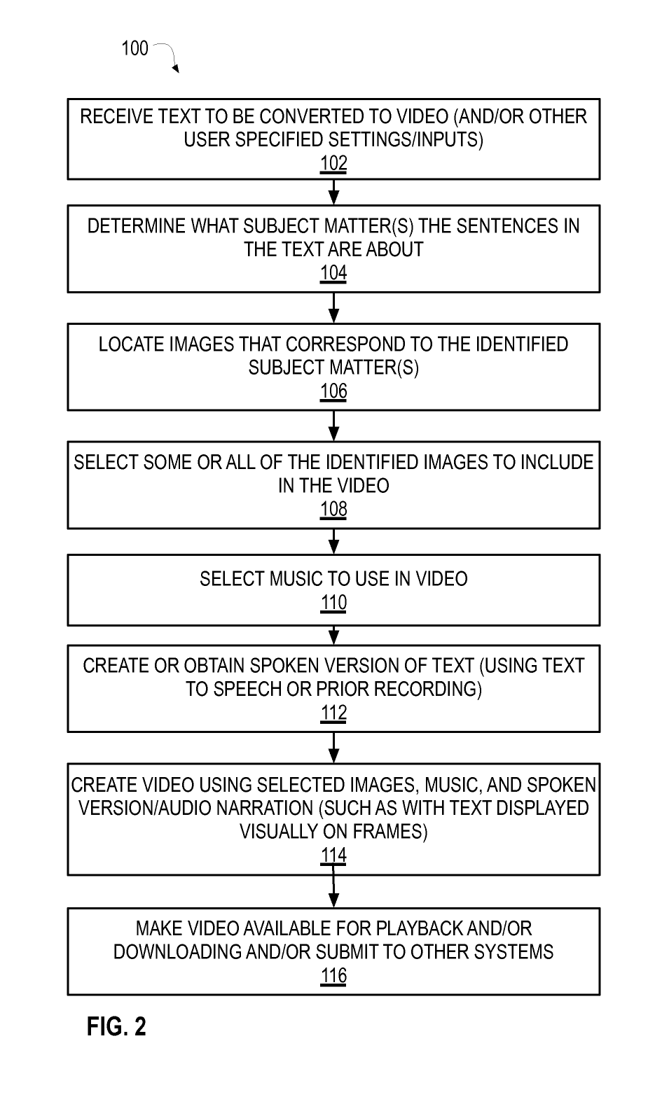

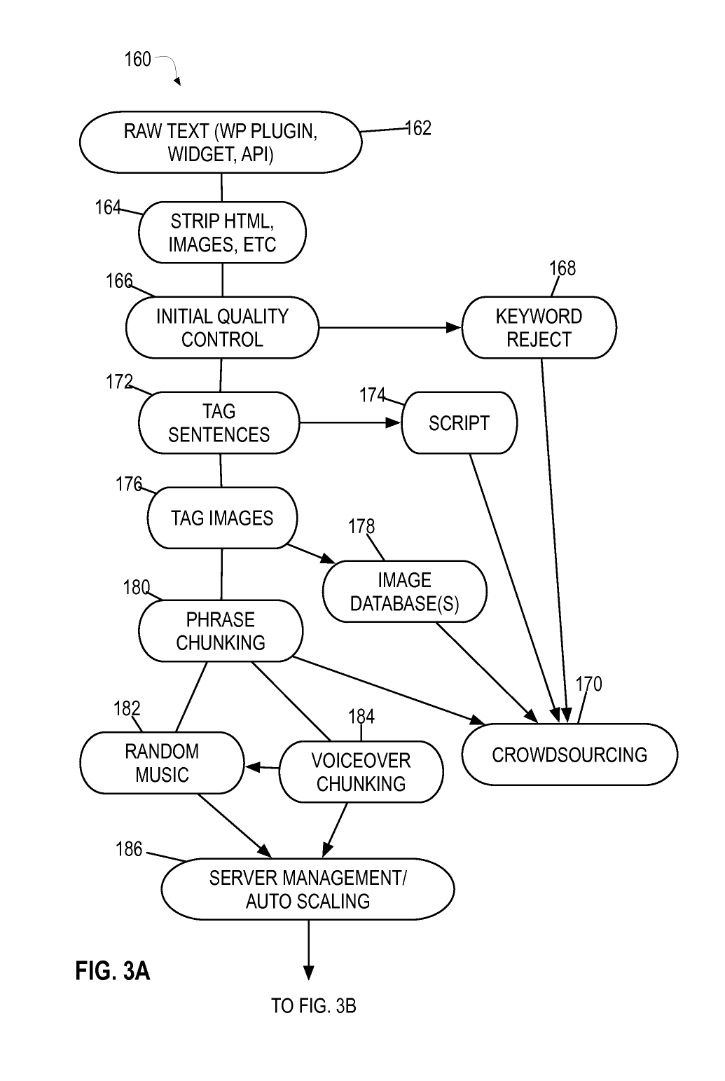

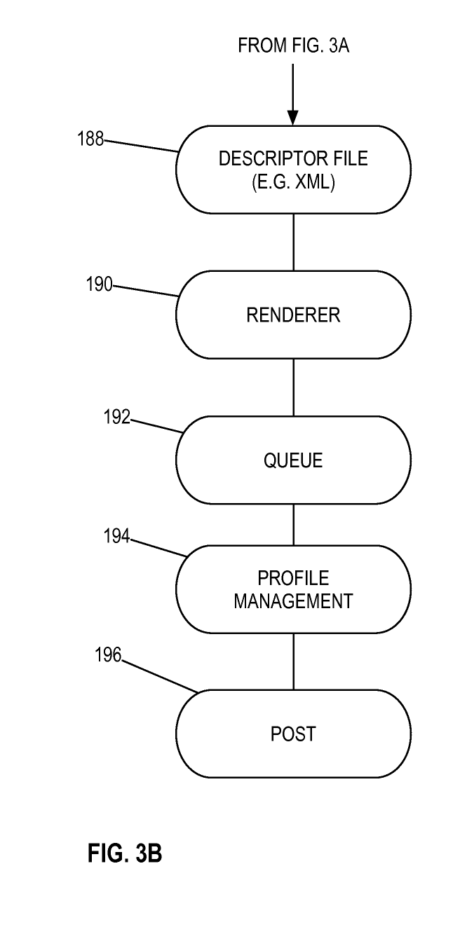

One or more data store(s) 24 can be used to store the videos and/or related information that are used to create the videos. Once a particular video has been created, the particular video can be provided to a video streaming service 26 or web site (such as YouTube, Viddler, the user's own blog, etc.) and/or to a user device for downloading. Once the video is hosted on some type of video streaming service 26 or web site, one or more users or web site visitors can playback the video 30 from a client device 28. Some exemplary processes that can be used for creating the video from the text are described in more detail in FIGS. 2-3.

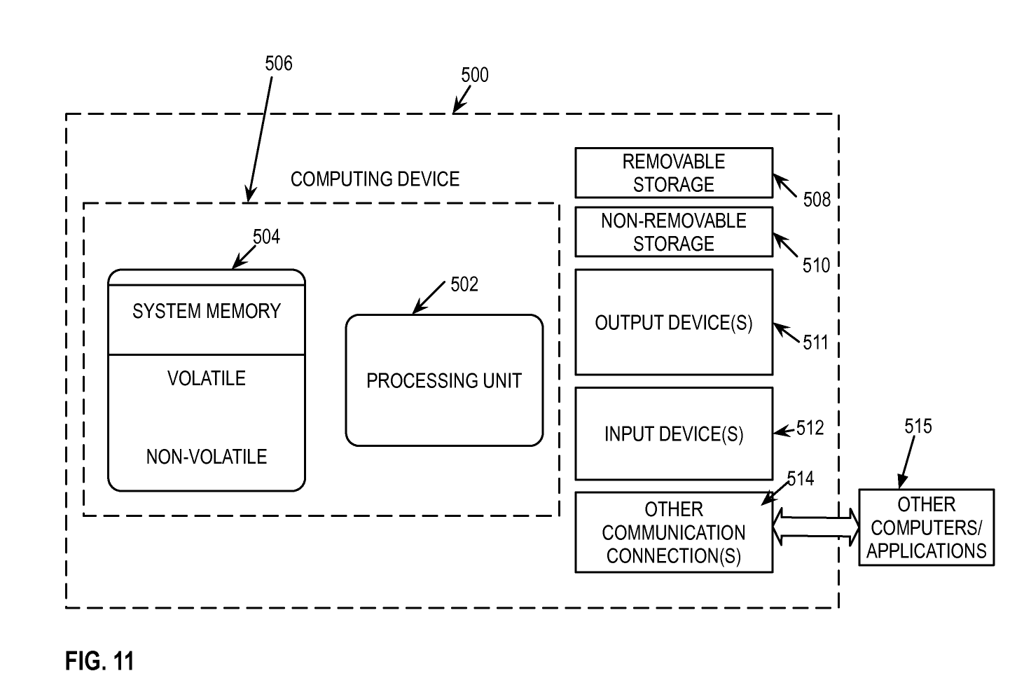

Turning now to FIGS. 2-10, the stages for implementing one or more implementations of video creation system 10 are described in further detail. In some implementations, the processes of FIG. 2-10 are at least partially implemented in the operating logic of computing device 500 (of FIG. 11).

FIG. 2 is a process flow diagram 100 for one implementation illustrating the stages involved in automatically creating a video from text that has been supplied. Text that is to be converted to a video is received (or retrieved) (stage 102), such as from an API, blog or web site plug-in, and/or another program that accepts the text. In one implementation, other user specified settings can also be received (stage 102), such as a visual theme for the video (such as one including a font selection to use for styling the words/images), other video settings, etc. System 10 determines what subject matter(s) the sentences in the text are about (stage 104). For example, the sentences are analyzed to determine what subject matter(s) they refer to, and the sentences are then tagged as being related to those particular subject matters.

Images that correspond to the identified subject matter(s) are located, such as from user uploaded images, an internal image database, and/or third party image database(s) (stage 106). In other words, system 10 performs a lookup to identify one or more images that correspond to the subject matter(s) that were identified in the text. Some or all of the images that are identified as being related to those subject matter(s) are selected for inclusion in the video (stage 108). Music can be selected for use in the video, such as music that is determined to be appropriate for the subject matter(s) of the text being analyzed (stage 110). The spoken version (audio narration) of the text is created or received, such as using text-to-speech conversion technology, or from a prior recording that was provided by a user or a voice over professional (such as through crowd sourcing) (stage 112).

A video is automatically created using the selected images, music, and/or audio narration (stage 114). In one implementation, the video can be produced for one or more targets, such as a small resolution mobile device, hi definition for DVD playback, normal web site playback, and/or in the preferred size by video sites such as YouTube, etc. In one implementation, the text is displayed visually on the frames of the video along with the images that were selected. Once the video has been created, it can be made available for playback, downloading, and/or for submission to other systems (stage 116). As one non-limiting example, the video can be displayed on the user's blog post along with the article that contains the text that was used to create the video. As another non-limiting example, the user could be presented with an option to download the video to a desired location. As yet another non-limiting example, the video could be distributed on behalf of the user to one or more video distribution tools or video sharing sites (such as YouTube, Viddler, etc.).

FIGS. 3A-3B are a process flow diagram 160 illustrating the more detailed stages involved in creating a video from text in another implementation. In alternate implementations, some of the stages described in FIGS. 3A-3B may be omitted and/or additional stages may be added. Starting with FIG. 3A, raw text is received (stage 162), such as from a Word Press or other blog/web site plug-in, an API, or a widget/tool that receives text from an end user or system. The text is analyzed and any HTML, images, or other formatting are stripped, when present, so that only the actual text remains (stage 164). Initial quality control is performed (stage 166) using a keyword rejection tool (stage 168) to reject any text that contains profanity, hate, occult, or other subject matters that are not permitted. In one implementation, crowd sourcing is optionally used (stage 170) to provide a human level of review to confirm that the automated selection was appropriate. In other implementations, crowd sourcing (stage 170) can be omitted.

The sentences in the text are analyzed to identify the subject matter(s) that they contain (stage 172). This is also referred to as sentence tagging. A script (stage 174) of the tagged sentences can optionally be provided to crowd sourcing (stage 170) to verify that the automated selections of the subject matter(s) for the text were actually appropriate given the text. Once the subject matter(s) of the text are identified, images are identified that are appropriate for the subject matter(s) (stage 176). This is also referred to as image tagging. Images for the identified subject matter(s) can be retrieved from an internal image database and/or from external image database(s) as appropriate (stage 178). Crowd sourcing (stage 170) can again be optionally used to help verify that the images that were automatically selected were appropriate for the particular text. Phrase chunking is performed (stage 180) to break up the sentences into readable text. For example, if a sentence is really long, it may be desirable to display that sentence across multiple slides. In some implementations, the break points where the sentence is separated onto different slides will ideally make sense to a viewer. Crowd sourcing (stage 170) can optionally be used to verify whether the automated phrase chunking was accurate. Random music can be selected (stage 182), such as music that is appropriate for the particular subject matter(s) of the text. Voiceover chunking (stage 184) is also performed, to convert the text to speech. The phrase chunks get sent to a text-to-speech engine for conversion. In other words, the text gets converted to speech using a computer. In an alternate implementation, a recording of the voice of a human could be used instead of a text-to-speech conversion.

In one implementation, server management/auto scaling (stage 186) is used to allow large volumes of videos to be processed for a variety of end users. During auto scaling, system 10 determines how long the video will be, and then calculates how much server time it will take to process that respective video. If there are not enough servers available to complete the processing, then additional servers are utilized (accessed and/or turned on) in an efficient manner. For example, in one implementation, cloud based servers (such as Amazon EC2 cloud servers) are used. Servers can be turned on and turned off in an efficient way based upon how many servers are needed to complete the videos that are awaiting creation. If there is time left on a server that has already been paid for or set aside for a period of time, then system 10 keeps using that server for additional video processing so that the money and/or resources for that server are not wasted.

Continuing with FIG. 3B, a descriptor file is created (such as in XML) (stage 188) that contains the various details about the video creation. The descriptor file gives the renderer details on how to create the video. The renderer (stage 190) then creates the video, such as according to the instructions contained in the descriptor file. The renderer can include text effects, motion graphics, and image effects, and can do so at random so that each video is unique. The renderer can send the videos to a submission queue (stage 192) so that the videos are created based upon submission time.

In one implementation, profile management (stage 194) is used to identify what accounts you have across different video sharing sites, social bookmarking sites, etc. The profile management tool can automate the creation of profiles across various sites if you don't already have them.

Once the video has been created, it can be posted (stage 196) to one or more sites (such as to a blog, third party video/other sites, and/or a video posting tool).

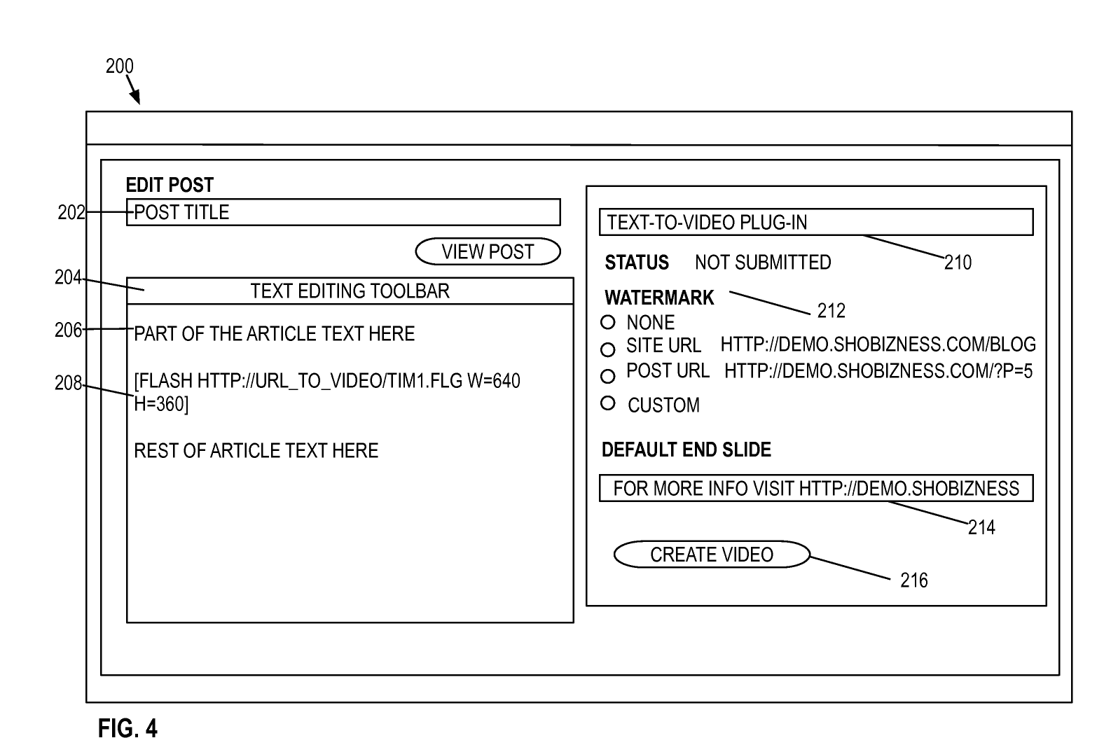

FIG. 4 is a simulated screen 200 for one implementation that illustrates a text-to-video plug-in for a blog or web site that facilitates automated video creation. For example, the plug-in can be used with Word Press, Blogger, or other blogging platforms to automate the creation of videos based upon the articles contained on the blog or web site. In the example shown, the article title 202 is shown, along with the body of the article 206. Using a text editor 204, formatting can be applied to the article, such as bold, underline, etc.

The text-to-video plug-in 210 allows the settings for the video to be specified for this post. For example, the submission status of the video is displayed. The watermark setting 212 can be specified to indicate whether or not the video should have a watermark, and if so, what that watermark should say. The default end slide setting 214 can be specified to identify what text should be spoken/displayed at the end of the video to encourage the user to take another action. The create video button 216 can be selected to create the video from the text of the article. In some implementations, the create video button may be omitted because the setting has been specified to create the video automatically upon saving the article. A link 208 to the automated video that has been created with the text-to-video plug-in 210 can be displayed within the article. That link 208 can control where the video will be displayed in comparison to the rest of the article text.

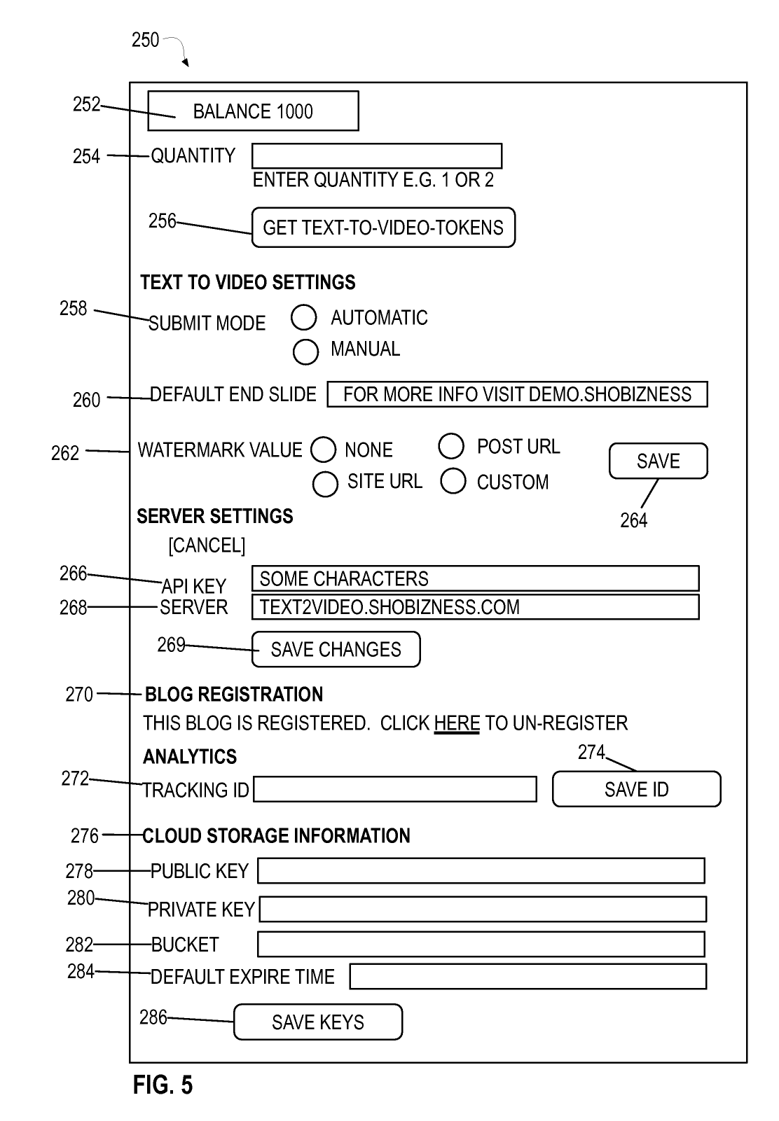

FIG. 5 is a simulated screen 250 for one implementation that illustrates a settings page for configuring an automated video creation plug-in for a blog or web site. The balance 252 is shown to indicate how many tokens are left for creating future videos. Additional text-to-video tokens can be purchased upon entering a quantity 254 and selecting the Get Text-To-Video-Tokens button 256. The text to video settings 258 can also be specified, such as to indicate whether the video submit mode should be automatic or manual. The default end slide setting 260 can be specified to indicate what should be displayed on the last slide of the video by default. The watermark value 262 can be specified to indicate what should be displayed as a watermark on the video throughout its playback, such as to encourage the user to visit a certain web site. The save button 264 allows the text to video settings to be saved.

Server settings are also displayed, such as for specifying an API key 266 and the server name 268 that are associated with a valid license to use the plug-in. The server settings can be saved upon selecting the Save Changes button 269. The registration info 270 is also displayed to indicate the license status and which blog(s) have been authorized to use the plug-in. A tracking ID 272 can be specified for integration with an analytics tracking tool, such as Google Analytics. An analytics tracking tool can provide additional details about the videos, such as number of times the videos were played. If specified, the tracking ID 272 can be saved upon selecting the save ID option 274. Cloud storage information 276 can also be specified, in cases where the user of the automated video creation tool desires to store the videos in a cloud-based storage location such as Amazon S3. The public key 278, private key 280, bucket 282, default expire time 284, and/or other appropriate options for configuring the cloud storage can be specified. The cloud storage information can be saved by selecting the save keys option 286.

FIGS. 4-5 are just exemplary illustrations to show how the plug-in could be used with blogs/web sites to automate the creation of videos from text (such as article posts or other contents). Numerous variations of the screens and options could be used in other implementations, as would occur to someone with ordinary skill in the computer software art.

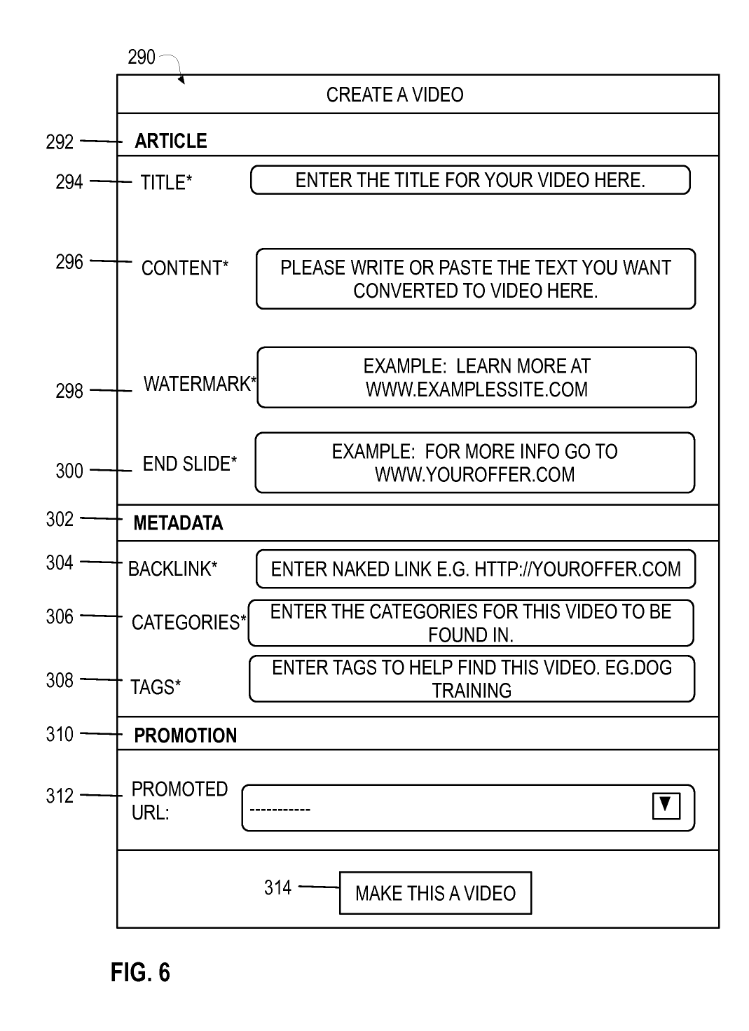

Turning now to FIG. 6, a simulated screen 290 is shown for one implementation that illustrates a user interface that allows a user to input text and other settings that are then used to automatically create a video. Article details 292 can be specified, such as the title 294, content 296, watermark 298, and end slide 300. The content 296 can include the text of the article (or post). Watermark 298 can include a URL or other textual information (such as a phone number) that the user wants to have displayed on each frame of the video, such as to encourage the viewer to take a certain action. End slide 300 can include details on what should be displayed on the last frame/slide of the video, such as a special offer, a web site to visit for more information, etc.

Metadata 302 can also be specified, such as the backlink 304, categories 306, and tags 308. Backlink 304 can include the URL of the web site or offer that the user wants to get increased rankings for in the search engines. Categories 306 can include the categories that the video should be posted in, so the video can be located more easily. Tags 308 can include key words that should be associated with the video, so the video can be located more easily. Promotion data 310 can include the promoted URL 312, which is the name of the web site that this video submission will be used for. In one implementation, promoted URL 312 is used to post the video back to the web site/blog that it was generated from. Other techniques could also be used for associating the video with the web site/blog that it was generated from.

Turning now to FIG. 7, a diagrammatic view of an alternate implementation of a video creation system 330 is described that allows a user to provide various inputs for use in creating videos, while allowing the video creation system to programmatically select various additional inputs that the user did not choose to specify. In one implementation, some or all of video creation module 332 is included as part of video creation module 12 of FIG. 1 (and any corresponding processes described in FIGS. 2-6). In other implementations, one or more parts of video creation module 332 can operate independently of video creation module 12 of FIG. 1.

Video creation system 330 includes video creation module 332, which can receive various inputs from a user of system 330, the inputs being items that the user wishes to use as part of the video. The inputs can include text 334 (such as the text of an article to be converted to a video), images 336, music 338, video 340, and narration 342 (such as audio files that correspond or relate to some or all of the text). In one implementation, the user could choose to specify just one input if desired, such as the text of the article to be converted to video. In another implementation, the user could choose to specify multiple inputs, such as the text of the article to be converted to a video, along with some music, images, and or narration that should also be used to create the video.

The inputs can optionally include additional variations 344 for one or more of the particular inputs to use in video spinning. With video spinning, multiple variations of a video can be generated based upon changing up the inputs. As a non-limiting example, two different versions of certain text could be provided—where one video could be created with version A of the text, and another video could be created with version B of the text, but with other factors being the same. Video spinning in general, as well as spinning module 350 are described in more detail herein.

Video creation module 332 is responsible for creating the video. Video creation module 332 first analyzes the one or more inputs that were received from the user (which could include one or more of text 334, images 336, music 338, video 340, narration 342, etc.). Based upon what the user did “NOT” provide, video creation module 332 then determines what additional inputs need to be generated programmatically and then generates such inputs.

Video creation module 332 also includes advanced modules that can be used in some implementations, such as auto detection module 346, synchronize/alignment module 348, and spinning module 350. Auto detection module 346 selects colors and styles to use in the video frames based upon what is detected to be included in the images. For example, if auto detection module 346 determines that a certain picture is dark, then it may put light text over that image so that the text will be easier to read. Synchronize/alignment module 348 synchronizes text with audio narration and/or music. In one implementation, synchronize/alignment module 348 operates programmatically to determine where a certain concept is mentioned in the text and the audio narration and/or music. Alternatively or additionally, user input can be provided to specify where certain text and audio narration and/or music correlate. In another implementation, synchronize/alignment module 348 can also perform music alignment, such as to align parts of the video (audio narration, text, and/or other aspects) to the dominant beat in the music, such as for better emotional impact.

Spinning module 350 can create multiple variations of a video, such as to allow the user to test one version of a video against another to see which one achieves a desired outcome better (e.g. which one gets the viewer to take the desired action, which one gets more views, etc.) Spinning module can use the optional variations 344 of the inputs that were specified by the user, and/or variations that are programmatically generated to create multiple variations of a certain video.

Once the video(s) has/have been created (such as multiple variations when spinning module 350 is being used), the finished video(s) 352 is/are output for usage, downloading, and/or distribution.

In one implementation, a video performance monitor 354 is provided that monitors multiple videos (on their respective destination locations) that were created with the video creation module 332. Video performance monitor 354 then provides performance data to the video creation module 332 to enable the video creation module 332 to use the performance data to improve future versions of the videos that are created. As a non-limiting example, if certain photos are determined to be helping videos achieve a better result, then those videos can be used in future videos or variations of the same video that get created in the future. As another non-limiting example, if a certain audio narration (or portion/segment thereof) is performing really well to achieve a desired outcome, then that audio narration (or portion/segment thereof) may be used in future videos and/or variations of the video in the future. Since video creation module 332 knows the various inputs that were used to generate a particular video, the data provided by video performance monitor 354 can be intelligently analyzed to help create the best of breed videos in the future.

Let's look at a non-limiting example to further illustrate this concept. Suppose the user provided the text of the article to be converted to a video, but did not provide anything else. In that instance, video creation module 332 may programmatically identify images that are related to the subject matter of the text. In this non-limiting example, video creation module 332 may also programmatically identify music and/or create a narration of the text using a text-to-speech module. These programmatically generated or selected inputs are then used in combination with the text specified by the user to create the video.

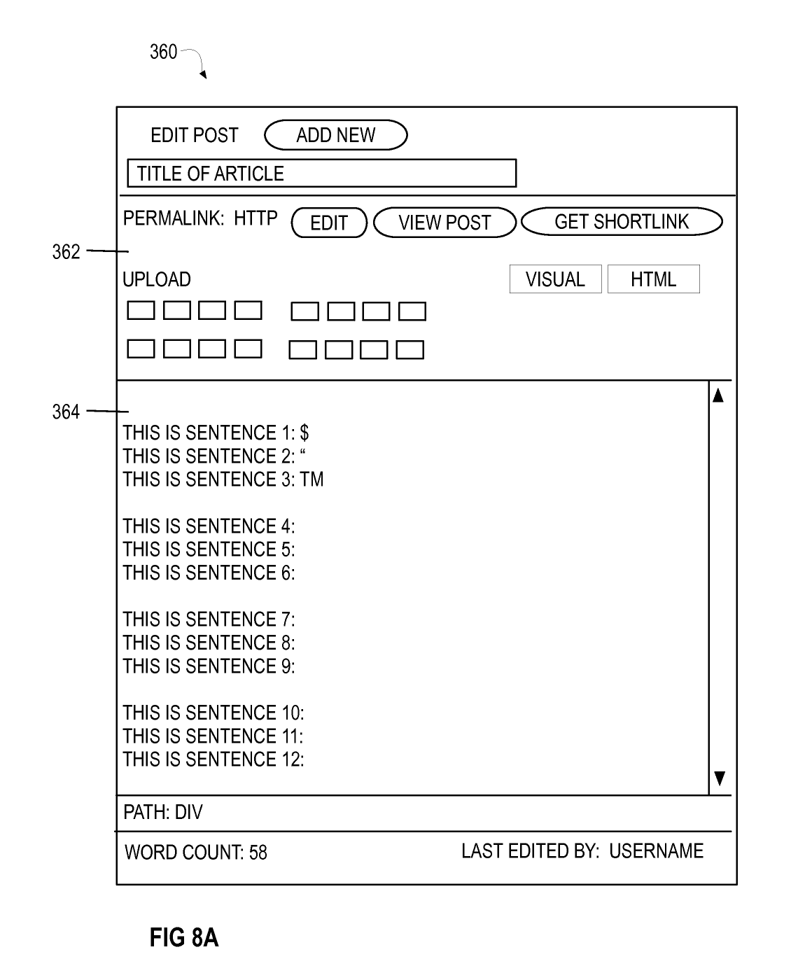

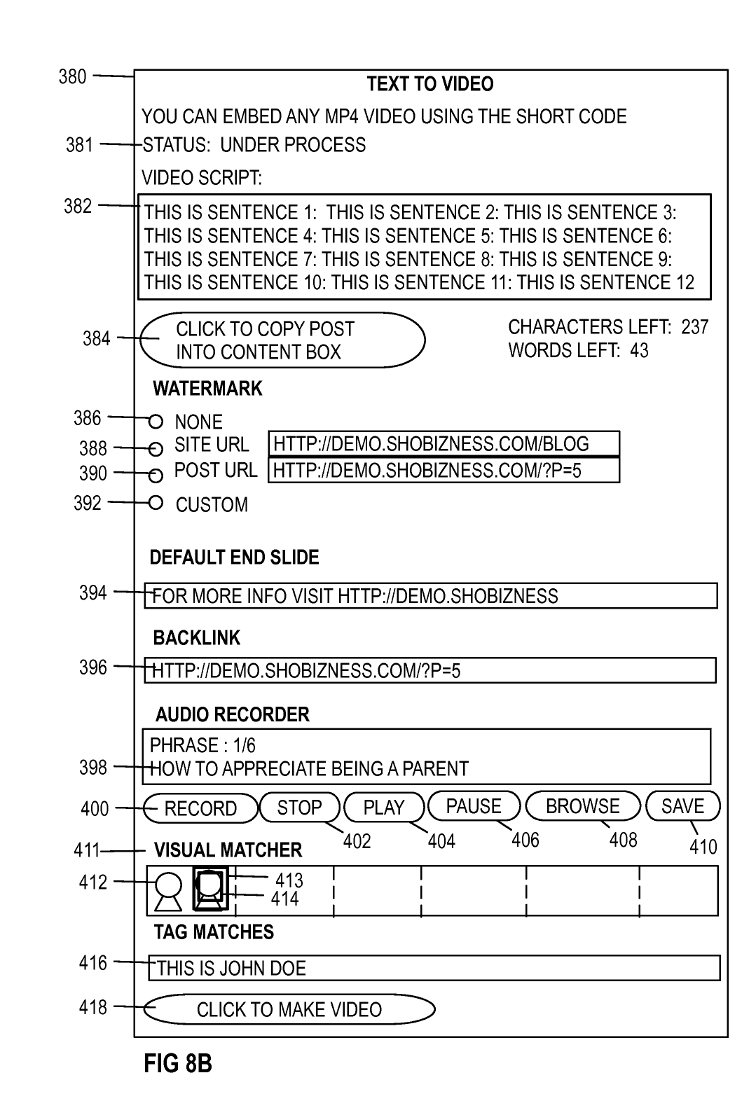

FIGS. 8A-8B are a simulated screen 360 for another implementation that illustrates a plug-in for a web site that facilitates automated video creation. In this non-limiting example, the user is able to specify additional inputs for use in creating the video (such as images and/or audio). The first part of simulated screen 360 includes a typical article posting features, where the title of the article, article editing tools 362, and article body 364 can be specified and/or utilized.

The text to video plug-in 380 is also contained on simulated screen 360, and allows the user to specify various settings for converting a particular article into a video. For example, a status indicator 381 is included, such as to provide a textual or graphical status of the video creation process. In this example, the video script field 382 is shown as a separate field from the article body 364, and the video script field 382 is automatically populated with the text from the article body 364. The user can also edit the video script field 382 independently from the article body 364, such as if the user wants a shorter, paraphrased, and/or teaser version of the article text to be used for creating the video. In other implementations, the video script field 382 and article body 364 could be in the same field, be in separate fields but updated at a different frequency, etc.

The click to copy option 384 can be used to copy the article body 364 into the video script field 382, such as if the user wants to over-write any changes that were made to the video script field 382 directly, and to make the two versions identical again.

The watermark details can be specified to indicate what type of information should be displayed on each (or just certain) frames of the video. In this example, watermark options include none 386, site URL 388, post URL 390, and custom 392. The default end slide 394 can also be specified to customize what appears on the final frame or slide of the video. The backlink value 396 can be used to specify what URL should be used to help rank the video higher in the search engines.

The audio recorder can be used to allow the user to either record an audio narration to be included in the video, or to upload an audio file for use as an audio narration. For example, the record option 400 allows an audio narration to be recorded. Stop option 402 stops the recording or playback of a particular audio narration. Play option 404 plays the recording of a particular audio narration. Pause option 406 pauses the recording or playback of a particular audio narration. Browse option 408 allows the user to browse the file system or third party server for an audio file to upload. Save option 410 allows changes made using the audio recorder to be saved. In another implementation, audio recorder can be used to upload and/or record music segments (such as those where the digital rights to use the music have been verified or are owned by the user).

A visual matcher 411 is also shown that allows the user to upload one or more images and/or videos for inclusion in the video. In one implementation, a minimum preferred zoom area 413 and a maximum preferred zoom area 414 can be specified for a specific image and/or video to allow the user to indicate what parts of the image or video should be emphasized the most in the video that is created. Alternatively or additionally, visual matcher 411 can be used in combination with tags to mark a certain image or video with text that corresponds to what is being displayed. As an example, the tag 416 can be correlated to the areas marked on image 412 (such as the minimum preferred zoom 413 area and a maximum preferred zoom area 414). In this example, John Doe is being identified as the tag, and is correlated with the section of the image 412 that John Doe is contained in. This is just a non-limiting example, and numerous other ways for correlating tags with sections of an image and/or video could also be used.

Once the desired settings are specified on simulated screen 360, including the text to video settings 380, the user can select the make video option 418 to have the video generated based upon the specified settings. In other implementations, some, all, and/or additional settings could be used for creating the video. The ones shown in FIGS. 8A-8B are just for the sake of illustration of a user interface that allows the user to provide multiple inputs for use in creating the video (such as text, video, audio narration, images, etc.).

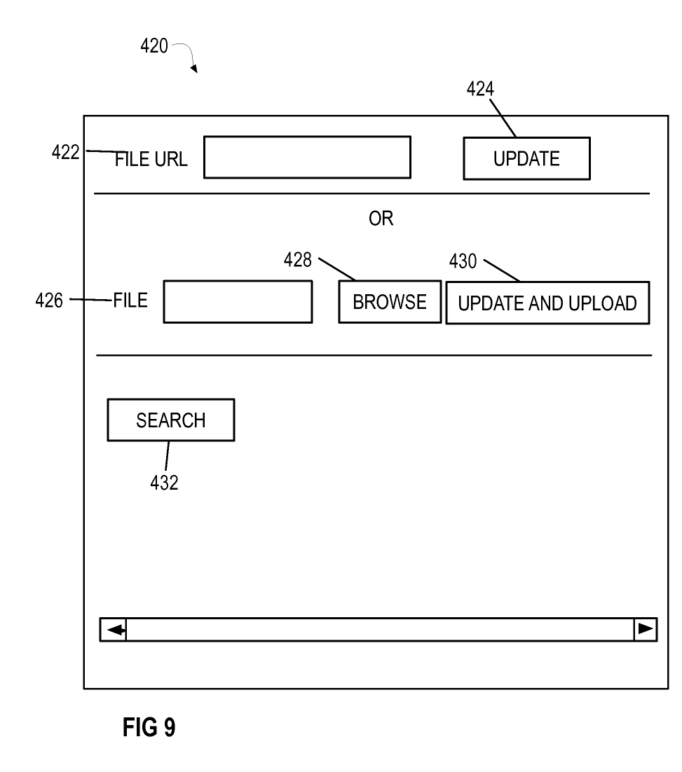

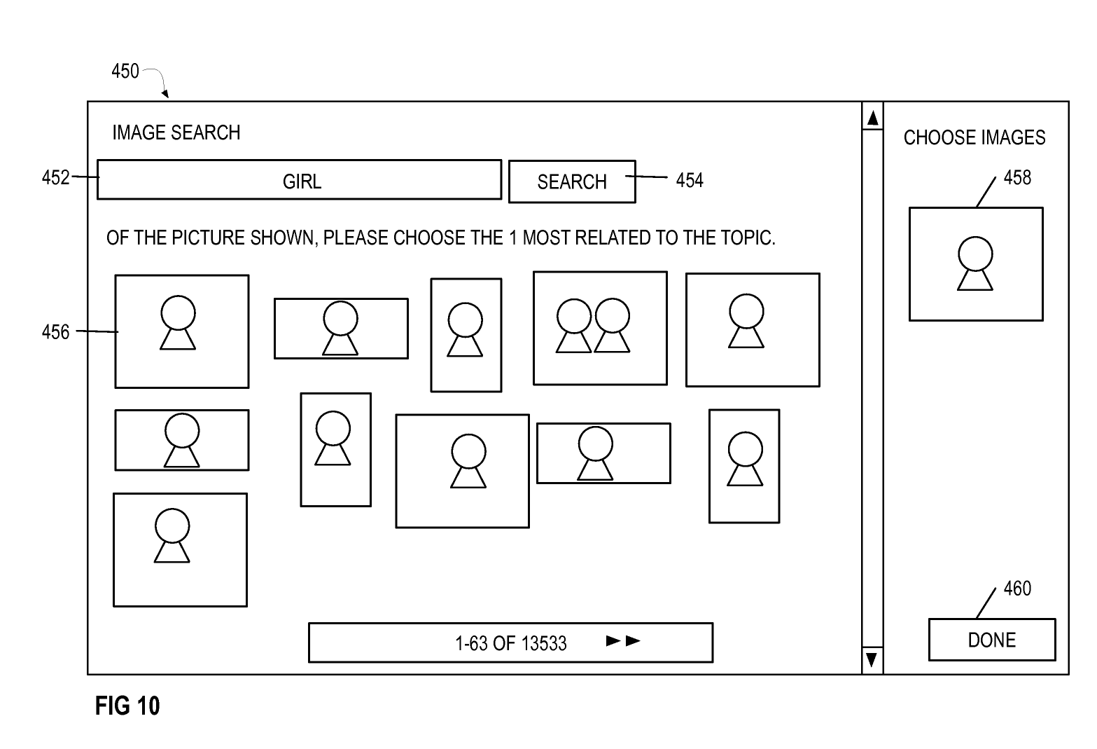

FIGS. 9-10 is a simulated screen 420 that illustrates selecting an image for inclusion in the video, such as with visual matcher 411 of FIG. 8B. In the example shown, a file URL 422 can be specified, such as if the image is located on a third party web site or server. Once selected, the update option 424 can be selected to load the image from the third party web site or server. A local file 426 can alternatively or additionally be specified, such as upon selecting the browse option 428, navigating to and selecting the desired file(s), and then selecting update and upload 430. A search option 432 can be specified to perform a key word search to locate an image from an internal or external image database. A screen such as the one shown in FIG. 10 can be displayed upon selecting search option 432. Then, upon entering the search criteria 452 and selecting the search option 454, a list of images 456 that match the criteria are displayed. The user can then select a desired image 458, and select done 460 to return to the prior screen with the desired image being added to the video creation project.

As shown in FIG. 11, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 11 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 11 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A computer-readable medium having computer-executable instructions for causing a computer to perform steps comprising:
receiving text to be converted into a video;
locating at least one image that corresponds to a subject matter contained in the text;
generating a spoken version of the text; and
creating the video using the at least one image and the spoken version of the text.

2. The computer-readable medium of claim 1, further having computer-executable instructions for causing a computer to perform steps comprising:
prior to creating the video, selecting at least one music segment to include in the video; and
wherein the creating the video step includes using the at least one music segment along with the at least one image and the spoken version of the text to create the video.

3. The computer-readable medium of claim 1, wherein the generating the spoken version of the text step is performed using a text to speech module.

4. The computer-readable medium of claim 1, wherein the generating the spoken version of the text step is performed using at least one audio file received from a user.

5. The computer-readable medium of claim 1, wherein the creating the video step includes putting at least a portion of the text on a plurality of frames of the video for visual display during playback of the video.

6. The computer-readable medium of claim 1, further having computer-executable instructions for causing a computer to perform steps comprising:
prior to creating the video, selecting at least one music segment to include in the video;
wherein the spoken version of the text is generated using a text to speech module; and
wherein the creating the video step includes using the at least one music segment along with the at least one image and the spoken version of the text to create the video.

7. The computer-readable medium of claim 1, wherein the text to be converted to the video is received automatically when a user saves a particular article to a web page.

8. The computer-readable medium of claim 7, wherein after the video is created, the video is placed on the web page with the particular article.

9. A system comprising:
a plug-in that integrates with a web site, the plug-in being operable to automate the creation of videos; and
wherein the plug-in is further operable to create a video from at least a portion of text that is contained in an article on the web site.

10. The system of claim 9, wherein the web site is based upon a WordPress platform.

11. The system of claim 9, wherein the plug-in automatically creates the video when the article is added to a particular page on the web site.

12. The system of claim 9, wherein the plug-in creates the video upon user request after the article has been added to a particular page on the web site.

13. An automated video creation system comprising:
a video creation module that is operable to receive at least one input from a user, the at least one input being selected from the group consisting of user specified text, images, music, video, and narration; and
wherein the video creation module is further operable to create a video from the at least one input from the user in combination with programmatically selected inputs, wherein the programmatically selected inputs are selected from the group consisting of programmatically selected text, images, music, video, and narration, and wherein the programmatically selected inputs are selected at least in part based upon the at least one input from the user.

14. The system of claim 13, wherein the video creation module is further operable to receive a particular narration from the user through an audio file upload module.

15. The system of claim 13, wherein the video creation module is further operable to receive a particular narration from the user through a recorder module.

16. The system of claim 13, wherein the video creation module contains a spinning module that is operable to create a plurality of different videos, wherein the plurality of different videos are varied by a specified criteria.

17. The system of claim 16, wherein the specified criteria used by the spinning module is based, at least in part, upon a plurality of inputs received from the user.

18. The system of claim 16, wherein the specified criteria used by the spinning module is based, at least in part, upon a plurality of inputs that are programmatically determined.

19. The system of claim 13, wherein the video creation module is further operable to create a plurality of videos simultaneously, and to communicate with an autoscaling module to automatically turn on an appropriate number of servers that are needed for creating the plurality of videos in the most efficient manner.

20. The system of claim 13, further comprising:
a video performance monitor that is operable to monitor a plurality of videos that were created with the video creation module, and to provide performance data to the video creation module to enable the video creation module to use the performance data to improve future versions of the plurality of videos that are created.
